(19) United States
(12) Patent Application Publication
(10) Pub. No.: US 2005/0216271 A1
(43) Pub. Date: Sep. 29, 2005

(54) Speech dialogue system for controlling an electronic device

(76) Inventor: Lars Konig, Ulm (DE)

Correspondence Address: BRINKS HOFER GILSON & LIONE, P.O. BOX 10395, CHICAGO, IL, 60610, US

(21) Appl. No.: 11/051,127

(22) Filed: Feb. 4, 2005

(30) Foreign Application Priority Data
Feb. 6, 2004 (EP) EPO 04002693.2

(51) Int. Cl. G10L 11/00

(52) U.S. Cl. 704/275

(57) ABSTRACT

A speech dialogue system (SDS) is provided for controlling an electronic device through speech control. A method for controlling an electronic device with a speech dialogue system is provided, using a speech dialogue system with a speech recognition unit. The speech recognition unit includes a control command determining unit, which is activated by a keyword, for determining a control command to control the electronic device. The method comprises the steps of receiving an acoustic input, spoken by a user of the SDS, containing keyword information and control command information; determining a keyword corresponding to the keyword information; activating the command determining unit, and determining a control command corresponding to the control command information. A speech dialogue system for use in a vehicle is also provided, comprising a speech recognition unit including a control command determining unit which is activated by a keyword spoken by a user of the SDS. The speech recognition unit is configured to activate the command determining unit for determining a control command upon receipt of an acoustic input comprising both keyword information and control command information. A computer program product is also provided, including one or more computer readable media having computer executable instructions for performing the method for controlling an electronic device via speech control.

### BACKGROUND OF THE INVENTION

1. Priority Claim.

This application claims the benefit of EPO 04002693.2, filed Feb. 6, 2004. The disclosure of the above application is incorporated herein by reference.

2. Technical Field.

This application is directed to a system for controlling an electronic device, and in particular a speech dialogue system for controlling an electronic device using a speech dialogue system.

3. Related Art.

Most electronic devices are controlled by the user by control commands which are input by a user using keys such as the keyboard of a computer, or by pressing buttons like in a hand held telephone. Increasingly, these electronic devices are also controllable by speech. Such electronic devices often include a speech dialogue system capable of analyzing acoustic signals, provided by a user in form of a spoken directive, to determine control commands which are then carried out by the electronic device. Control commands may also comprise parameter settings such as a telephone number or radio stations.

Speech operated devices are useful in environments where the hands of the user are needed to perform other activities, for example in a vehicular environment where the user needs his or her hands to safely drive the vehicle. A speech dialogue system that operates electronic devices, such as a car radio, a telephone, a climate control or a navigation system helps in improving safety. With a speech dialogue system, it is no longer necessary to draw the driver's attention from traffic.

A major drawback with current speech dialogue systems is that the user-friendliness of these devices is still very limited. For example, the device does not adapt itself to the way the user wishes to carry out his dialogue with the device, but rather the user has to learn how to carry out the dialogue so that the electronic device can understand the provided speech commands. In addition, prior to inputting control commands via a speech input, the user is may be required to press a special button, usually referred to as the push-to-talk lever, to initiate a speech dialogue with the speech dialogue system.

Therefore, there is a need for a speech dialogue system for controlling an electronic device to provide improved user friendliness with respect to how the speech dialogue is carried out.

### SUMMARY

The application provides a system for controlling an electronic device via speech control, using a speech dialogue system (SDS) with a speech recognition system. The speech recognition system may comprise a control command determination unit to be activated by a keyword for determining a control command to control an electronic device. The system provides a method for controlling an electronic device using a speech dialogue system (SDS) with a speech recognition system. The speech recognition system receives an acoustic input, spoken by the user, that may contain keyword information and control command information. The speech recognition system may determine a keyword corresponding to the keyword information provided. The command determination unit may be activated to determine a control command corresponding to the control command information.

The application also provides an SDS for controlling an electronic device. The SDS provides a speech recognition unit, which may comprise a control command determining unit. The control command determining unit may be activated by a keyword for determining a control command for controlling the electronic device. The speech recognition system may be configured to activate the command determining unit to determine a control command upon receipt of an acoustic input. The application further provides a speech dialogue system where the SDS is used in a vehicle, in particular a car, incorporating a SDS to control electronic devices in the vehicle.

The application further provides a computer program product, which may comprise one or more computer readable media having computer executable instructions for performing a method for controlling an electronic device via speech control. The computer executable instructions may perform the method as follows. The instructions may execute the step of receiving an acoustic input containing keyword information and control command information. The instructions may then execute the step of determining a keyword corresponding to the keyword information. The instructions may execute the steps of activating the command determining unit, and determining a control command corresponding to the control command information.

Other systems, methods, features and advantages of the invention will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 illustrates a flow diagram of the speech control of an electronic device.

FIG. 2 illustrates a flow diagram of the speech control of an electronic device with response verification steps shown.

FIG. 3 illustrates a flow diagram of the speech control of an electronic device with storage unit searching shown.

FIG. 4 illustrates a flow diagram of the speech control of an electronic device with background noise and signal conversion steps illustrated.

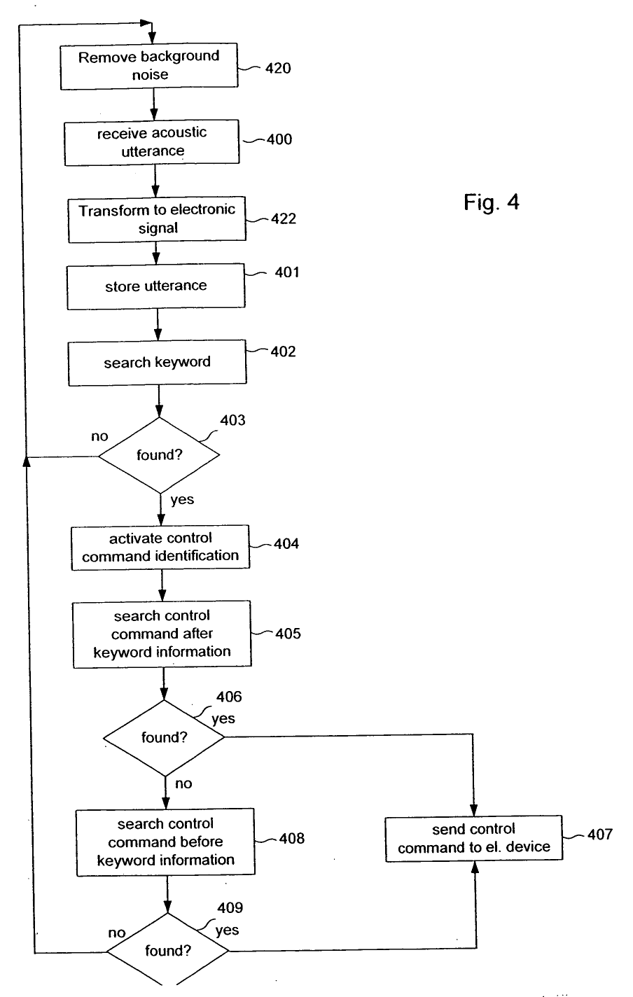

FIG. 5 presents a block diagram of the speech dialogue system.

FIG. 6 presents a block diagram of the speech dialogue system showing a storage unit, acoustic and/or optical output unit and/or noise reduction unit.

### DETAILED DESCRIPTION OF THE PREFERRED EMBODIMENTS

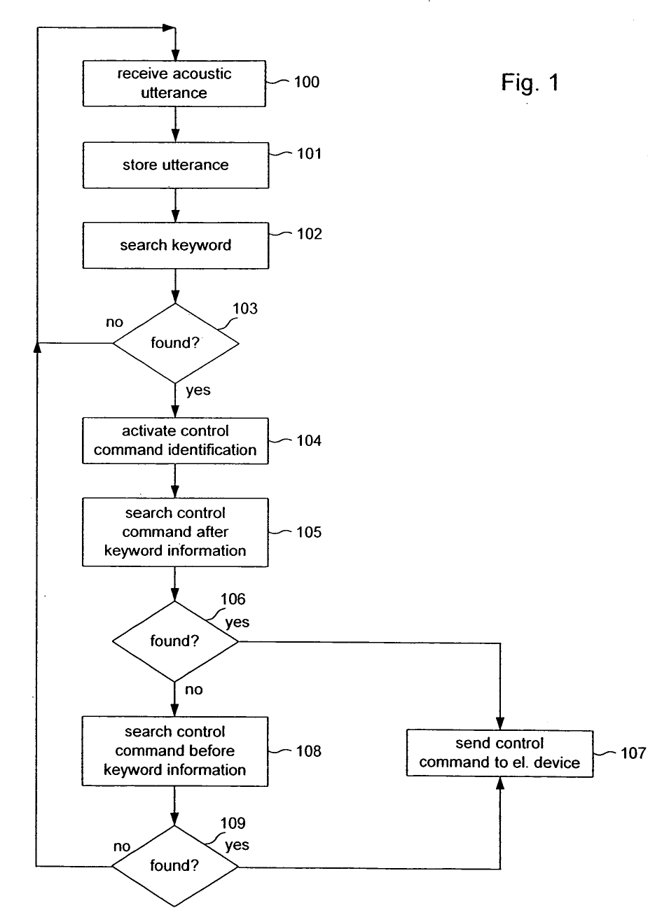

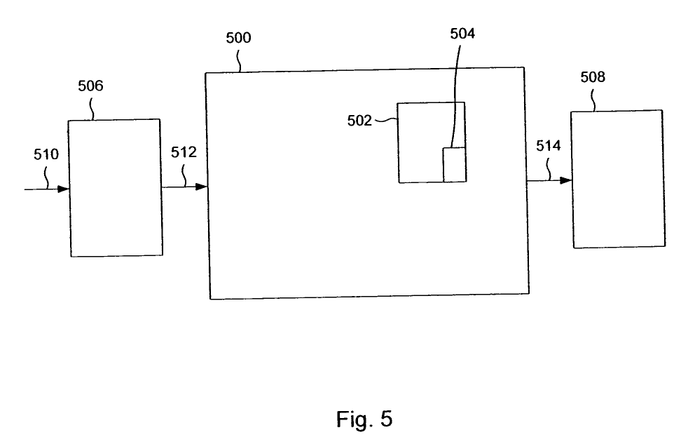

FIG. 1 illustrates a method for controlling electronic devices via a speech dialogue system (SDS). With reference to the block diagram of a speech dialogue system shown in FIG. 5, the acoustic input unit 506 (see FIG. 5) may receive 100 an acoustic input 510, spoken by the user, which may comprise one or more words. The acoustic input unit 506 may create electric signals 512 out of the acoustic input 510, which may then be processed by the noise suppression unit 507 in order to improve the signal-to-noise ratio. This may involve removing at least a part of received background noise during the step of receiving an acoustic input. Thus, the erroneous identification of control commands may be prevented and the reliability of control command recognition is improved. The term “unit” is not limited to a discrete component, but may include a portion of a component or may include multiple components. Thus, the units described herein may each be a separate component, parts of one or more components or the like.

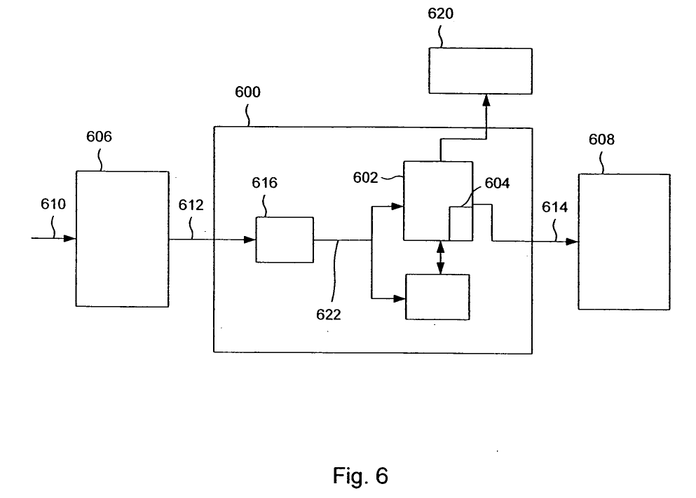

The received signals may then be stored 101 by the storage unit 618 (See FIG. 6). The storage unit 618 may be a cacheable memory such as volatile memory chips or flash memory units to allow fast access by the SDS 500. By providing the storage unit 518, the acoustic input 510 input during a predetermined time duration may be kept in the memory of the SDS 500 so that analysis is faster as compared to on-the-fly-only analysis. For example, once a keyword has been identified, the keyword may be rechecked to ensure that, indeed, out of the context of the input using semantic rules, the keyword was pronounced to start a speech dialogue. If, for example, the keyword was “car,” there may be a difference in “car, change the radio station” compared to “I bought a new car.” In both cases, the SDS 500 would identify the word “car.” However, having stored the input and using predefined semantic rules, the SDS 500 may determine that, in the first case, the user actually wants to control an electronic device 508 using the SDS 500, whereas, in the second case, the user is talking to someone about his car, and thus not related to a speech dialogue to control an electronic device 508. For the purposes of this application, the terms “identify”and “determine,” and their various forms, are used interchangeably when referring to the determination or identification of a keyword or control command.

The speech recognition unit 502 may read the stored input or at least a part of the stored input from the storage unit 618. The speech recognition unit 502 may also directly receive the acoustic input from the acoustic input unit 506 or from the noise suppression unit 616. The speech recognition unit 502 may then start searching for keyword information 102. The keyword information advises or indicates to the speech dialogue system that the user wishes to carry out a speech dialogue with the system to control an electronic device. Thus, the keyword, which is identified by the speech dialogue system out of the provided keyword information, may be directed solely to the speech dialogue system without any further influence on the functioning of the electronic device. In contrast, the received control commands may be only directed to controlling the electronic device.

To carry out the speech recognition, the speech recognition unit 502 may analyze the received electric signal by performing, for example, a Fourier transform. The recognition may be based on a hidden Markov model or neural networks capable of determining words out of a continuous speech input comprising more than one word. The speech recognition unit 502 therefore may comprise software and/or firmware embodied in the SDS 500 to execute the algorithms described. Thus, the keyword and control command may be determined from one acoustic input.

The speech recognition unit 502 may identify the received keywords by comparing the words or a combination of the words with a first-vocabulary set comprising keyword vocabulary elements to determine whether the user has pronounced one of the keywords present in the first vocabulary set 103. The SDS 500 may continuously analyze the received acoustic signals to check whether the user has pronounced keyword information, thus indicating to the SDS that he wants to provide a control command for an electronic device 508. The first vocabulary set may comprise keywords, where one keyword may actually be a combination of several words. If a keyword is not found, steps 100-102 are repeated.

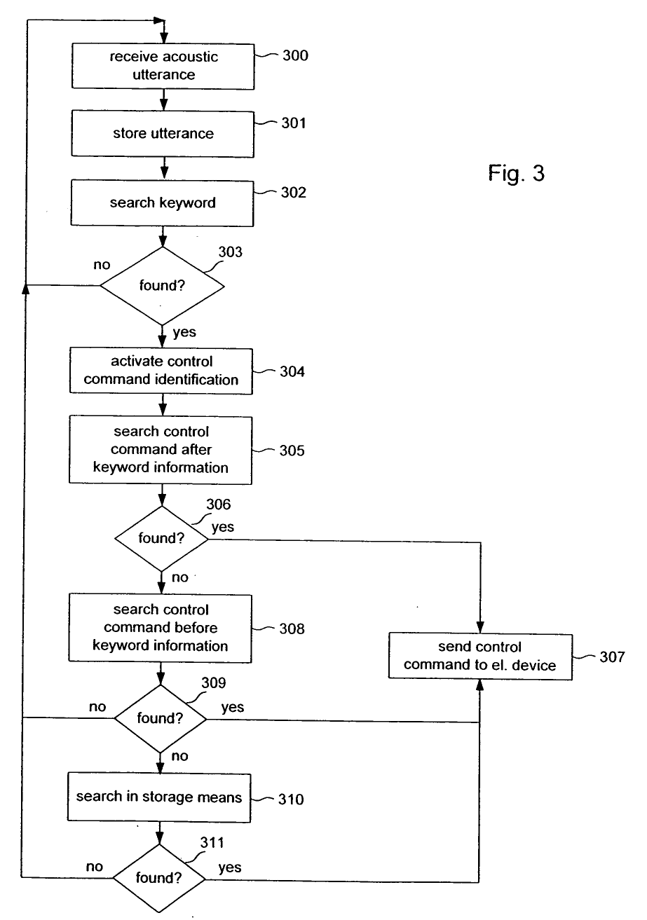

Alternatively, the SDS 500 may check 310 (see FIG. 3) whether new signals have been stored in the storage unit 618 and determine whether these new signals contain keywords 311. The user of the SDS 500 does not need a push-to-talk lever. The user does not need to 1) provide a keyword; 2) wait for a reaction from the SDS 500 to input control commands; and 3) finally provide control commands through a second input. Thus, the user can carry out a dialogue with the SDS 500 approximating a typical speech dialogue among humans.

Keyword information to activate the control command determining unit 504 may be provided in a number of ways. Several words or a combination of words can be used. For example, a user may define his or her own keywords or the keywords may be predetermined by the manufacturer. The user does not necessarily have to remember one, and only one, keyword.

If the speech recognition unit 502 has identified a keyword, the control command determining unit 504 may be activated 104 and start searching for control command information in the part of the input that comes after the keyword information 105. Similar to the way the keyword is found, a control command may be identified by comparing determined words or a combination thereof with a predetermined second vocabulary set of control command vocabulary elements to identify a control command out of the provided control command information.

The second vocabulary set of the speech dialogue system may be such that, for at least one control-command, the second vocabulary set includes more than one corresponding vocabulary element. For example, if the user wishes to drive home and wants the navigation system to calculate the best-suited route, he can accomplish this in several ways. For example, the driver may state “I want to drive home,” or “show me the way how to drive home.” Alternatively, the driver may input his home address including name of the city, street and house number.

These different inputs may comprise different sets of control command information but lead to the same control commands that the speech dialogue system outputs to a navigation system. In addition, at least one vocabulary element of each of the first and second vocabulary sets may be the same. Thus, a dedicated keyword to inform the speech dialogue system that control commands have been input is not necessary. By pronouncing control command information at the same time, the keyword information may be provided and the SDS 500 knows that both 1) control command determination will be started and 2) the control command is already input.

The speech recognition unit 502 may be configured to determine a keyword from keyword information including more than one word. Additionally or alternatively, the control command determining unit 504 may be configured to determine a control command from information comprising more than one word. The words of the keyword information and/or the control command information do not have to be in any particular order in the input 510, but can be positioned anywhere in the input 410. For example, an input such as “show me the way home” may be understood by the SDS 500 from the terms “show,” “way,” and “home,” that the user wants to use the navigation system to drive back home.

If a control command has been identified, the speech recognition unit 502 may send the control command 107 to the electronic device 508 where the command is executed 107. If, on the other hand, no control command information has been ascertained 106 in the information after the keyword, the control command determining unit 504 may start searching the acoustic input 510 prior to the keyword information to check whether the user made the control command prior to the keyword 108.

If the keyword is composed of more than one word, the control command determining unit 504 may also be configured to search the acoustic input 510 in between the words representing the keyword. The user can provide both the keyword and the command control in the same input without pause or prompt from the SDS 500. For example, if the term “car” corresponds to the keyword, then the input “change the radio station, car” will be understood by the SDS 500 and lead to changing the radio station. After determining the keyword “car,” the SDS 500 can analyze the part of the input which has been pronounced prior to announcing the keyword. The same is, of course, also possible when the keyword is pronounced in the middle of control command information, or when the control command information is built up of several parts or words. The user can efficiently carry out a dialogue with the SDS 500 without distracting the user with multiple requests for input.

If a control command is found after 109 a keyword, the speech recognition unit 502 sends the control command to the electronic device 508 where the control command may be carried out 107. If, on the other hand, no control command is found 109 in the acoustic input 410, the process may be repeated and eventually a second acoustic input provided from the user may be analyzed for the presence of a control command.

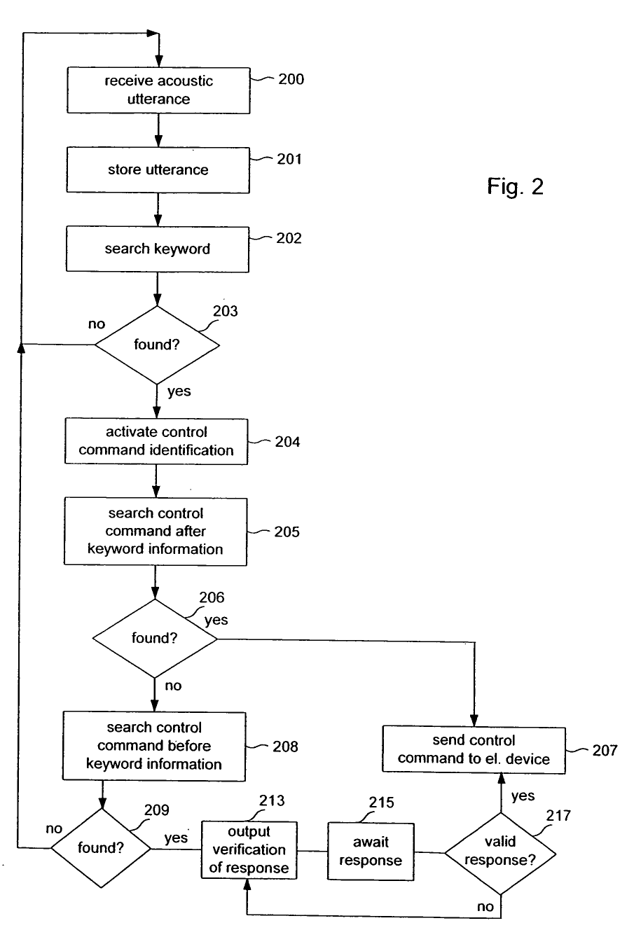

FIG. 3 depicts a sequence in which the SDS 500 searches 310 the storage unit 618 to determine if new signals have been stored 311 in the storage unit 618. Once the speech recognition unit 502 has determined a keyword and/or a control command 209 (see FIG. 2), the SDS 500 may be configured to output a message 213 via an acoustic or optic output unit 620 to the user to ask for confirmation that the user indeed wished to provide speech input to control an electronic device 608. The SDS 600 may be configured to await a confirmation or rejection command confirming or rejecting the determined control command. Typical messages may include “speech dialogue system turned on, do you want to proceed” or “the speech dialogue system determined that you wish to change the radio station to FM 94.8, please confirm.” The SDS 600 may then await a reaction from the user 215. If the reaction confirms that the identified keyword and/or control command is the desired action, the SDS 600 may send the control command to the electronic device 207. If the SDS determines a keyword or a control command but it was not the user's intention to start a speech dialogue with the system, the user may reject the application of the identified control command 213.

The following examples are illustrative of a speech dialogue between a user and an SDS.

### EXAMPLE 1

User: “SDS, I want to phone.”

Out of this statement, the SDS (500 or 600) may identify the keyword “SDS” and then look for a control command. In this example, the control command would be “telephone.” Based on the keyword and control command determination, the SDS will inform the telephone that the user is going to make a phone call and at the same time may ask the user to provide the telephone number he wants to call.

### EXAMPLE 2

User: “I want to phone, SDS.”

In this example, the keyword for activating the control command determining unit (504 or 604) comes after the control command information in the user's request to the SDS. However, the SDS (500 or 600) may be configured to search for control command information at any location in the user's statement, including prior to stating the keyword information. Thus, as in the first example, the SDS understands the keyword “SDS” and the control command “telephone” and will carry out the same actions as described.

### EXAMPLE 3

User: “I want to use the phone.”

In this case, no independent keyword information is provided. However, the SDS (500 or 600) may be configured to determine that the user wants make a phone call. However, the presence of the term “phone” may not be sufficient for the SDS to determine that the user wants to wants to make a call, since the user may also say this term in a conversation he has with another occupant of the vehicle. Thus, the SDS (500 or 600) may be configured to analyze the whole sentence to find out whether the user wishes to make a phone call. In this case, the combination of “use” and “phone” together with the word “want” may indicate to the SDS that indeed the user wants to make a telephone call.

### EXAMPLE 4

User: “I want to ring home”

In this example, the request presents a more complex control command. First, that the user wants to make a phone call and, second, the SDS (500 or 600) should look up the telephone number that corresponds to the term “home.” In another example, the request may include a statement such as “I want to drive home.” Here, the SDS (500 or 600) may determine that this corresponds to keyword information, analyze the control command information, and subsequently inform the navigation system that a route to the home address needs to be prepared and provided to the user.

FIG. 5 illustrates a speech dialogue system for controlling an electronic device (SDS) 500. The SDS 500 may receive acoustic inputs 510, which may comprise acoustic inputs from a user of the SDS 500 via an acoustic input unit 506. The acoustic input unit may comprise, for example, a microphone. The acoustic input unit 506 does not have to be an integral part of the SDS 500, as shown in FIG. 5. For example, in an automobile, the SDS 500, as one unit, may be located at one place in the vehicle and the microphone 506, or microphones (such as one per passenger seat), is located such that receipt of the acoustic input is optimized. In other applications, such as a handheld electronic device, the acoustic input unit 506 may be an integral part of the SDS 500

The SDS 500 may be connected with an electronic device 508, which like the acoustic input receiving unit 506, as shown in FIG. 5, may be an independent unit. Depending on the application, the electronic device 508 may also be combined with the SDS 500. The SDS 500 may be an integral part of the electronic device 508. Although FIG. 5 illustrates a single electronic device 508, the SDS 500 may be configured to control more than one electronic device. Thus, a SDS 500 mounted in a vehicle may be used to control several devices, such as an entertainment system like a CD player, radio, or DVD player; a navigation system; a climate control system; a telephone; an on-board computer, and/or voice-activated vehicle control command units.

As shown in FIG. 5, the acoustic input receiving unit 506 may receive an acoustic input 510 from a user of the SDS 500. The acoustic input unit 506 may transform this received acoustic signal into an electric signal 512 output the signal to the SDS 500. Inside the SDS 500, the received input may be analyzed by the speech recognition unit 502. If the input contains keyword information, the control command determining unit 504 may be activated to look for control command information contained in the acoustic input 510. If control command information is present in the input 510, the control command determining unit 504 may determine the corresponding control command 514 which is then output to the electronic device 508. The control command 514 may be executed at the electronic device 508.

To perform speech recognition, the speech recognition unit 502 may analyze the received electric signal by performing, for example, a Fourier transform. The recognition may be based on a hidden Markov model or neural networks capable of identifying words out of a continuous speech input comprising more than one word. The speech recognition unit 502 thus may comprise software and/or firmware embodied in the SDS 500 to execute the algorithms described. Thus, the SDS 500 may identify the keyword and a control command out of one acoustic input.

The acoustic input 510 is not limited to spoken words, but may include characters or numbers. The acoustic input 510 may comprise more than one word. The speech recognition unit 502 therefore may be configured to identify individual words or combinations of words from the acoustic input. The determined words or a combination of determined words may be compared to a predetermined vocabulary set. In one example, the SDS 500 may comprise two vocabulary sets. The first vocabulary set may include keywords, where one keyword can be a combination of several words. The SDS 500 may be configured such that if the speech recognition unit 502 recognizes a keyword out of the provided keyword information that is part of the acoustic input 510, the control command determining unit 504 is activated. Then the acoustic input 510 may be searched for control command information.

The search may comprise comparing the determined words or a combination thereof with a second vocabulary set comprising vocabulary elements related to control commands. In particular, more than one vocabulary element may be related to one control command, so that different types of control command information lead to the same control command. The vocabulary sets may be designed such that at least part of each of the two vocabulary sets are the same. For example, each control command may also represent a keyword at the same time, such that to activate the control command determining unit 504, the user does not have to input further keyword information other than control command information.

FIG. 6 illustrate additional components to a speech dialogue system 600. The properties and features of the acoustic input 610, the electric signal 612, and the control command 614 of FIG. 6 correspond to the acoustic input 510, the electric signal 511, and the control command 514 as described with reference to FIG. 5. As with the SDS 500 illustrated in FIG. 5, the SDS 600 may be in communication with an acoustic input unit 606 and an electronic device 608. The SDS 600 comprises a speech recognition unit 602, which may further comprise a control command recognition unit 604. In addition, the SDS 600 may comprise a noise suppression unit 616 and a storage unit 618. The noise suppression unit 616 may be an integral part of the acoustic input receiving unit 606. As shown, the SDS 600 may be in communication with an acoustical or optical output unit 620, such as loudspeakers or a display. The output unit 620 may be an integral part of the SDS 600 or, as shown, an additional unit 620. The acoustic and/or optical output unit 620 may be shared with other applications along with the electronic device 608, such as when one display is provided to serve multiple devices like a navigation system, a DVD player, audio entertainment system, and the SDS 600.

The electric signal 612 may be generated by the acoustic input unit 606 upon receiving the acoustic input 610 from a user. The electric signal 612 may be passed through the noise suppression unit 616. The noise suppression unit 616 may include various filters, such as adaptive noise cancellers (ANCs) and/or acoustic echo cancellers (AECs). Thus, the quality of the signal may be improved and the signal-to-noise ratio increased, particularly in a vehicular environment where the noise level can be relatively high due to, for example, engine noise, noise from the outside, or noise from entertainment sources such as the radio, a cassette player, or a CD player. Alternatively, the noise suppression unit 616 may be part of the acoustic input unit 606. In addition, microphones used in the acoustic input unit 606 may be directional microphones that receive signals from the direction of the positions of the occupants of the car. The noise suppression unit 616 may thus assist in preventing the erroneous identification of control commands, and lead to the further improvement of the user-friendliness and the stability of the SDS 600.

The enhanced signal 622 may be transmitted to the speech recognition unit 602 where keyword information may be searched. If a keyword is found, control command information may be searched for, as previously described with respect to the SDS 500 described above. In parallel, the enhanced signal may be stored in the storage unit 618 such that, if necessary, the speech recognition unit 602 may receive at least a part of the stored signal via the storage unit 618. The control command determining unit 604 may also search for control command information in the acoustic input 610 prior to the keyword information. Storing at least part of the received signal has the advantage that more precise analysis can be carried out off-line, for example, if the SDS 600 needs to do further processing to identify a keyword or control command. The SDS 600 then can access the stored signal without distracting the user with multiple requests for input if the speech recognition unit 602 cannot immediately identify a keyword and/or control command. The storage unit 618 may be configured to store data corresponding to a predetermined time interval and, thus, continuously remove the earliest entry to add new incoming data. Alternatively, the enhanced signal 622 may be transmitted just the speech recognition unit 602 or just the storage unit 618. For example, the enhanced signal 622 may be transmitted only to the storage unit 618, from which the speech recognition unit 602 may receive signals.

Once the speech recognition unit 602 has identified a keyword and/or a control command, the SDS 600 may be configured to output a message through the acoustic or optic output unit 620 to confirm that the user desires to control an electronic device 608. Typical messages may include “speech dialogue system turned on, do you want to proceed,” or “the speech dialogue system determined that you wish to change the radio station to FM94.8, please confirm.” The SDS 600 may await a reaction from the user. If the user's reaction confirms the determined keyword and/or control command, the electronic device 608 may perform the control command. Where only keyword information has been input by the user, the SDS 600 may await the input of a control command. Where the SDS 600 identifies a keyword or a control command, but the user did intend to initiate a speech dialogue with the system, the user may reject the application of the determined control command.

The SDS (500 or 600) may be incorporated into any environment that requires hands-free operation of an electronic device. Because of this, the SDS (500 or 600) may be particularly useful in vehicles, particularly cars. A vehicle is not limited to an automobile but may include land vehicles, marine vehicles and air vehicles. The SDS (500 or 600) may be used in vehicles where the electronic device (500 or 608) may be a cellular telephone, an audio and/or video entertainment system like a radio, CD or DVD player, or navigation system, or climate control system.

The system may also be a computer program product including a computer readable medium, such as disk media like floppy disks, CD's, DVD's, or solid state memory like hard drives or flash memory. The computer readable medium may have stored on it a computer readable program code adapted to perform the steps for controlling an electronic device using a speech dialogue system as illustrated in FIGS. 1-3 and described above.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

1. A speech dialogue system (SDS) for controlling an electronic device comprising:
a speech recognition unit; and
a control command determining unit;
where the speech recognition unit is configured to receive an acoustic input comprising keyword information and control command information, to identify a keyword from the keyword information, and to activate the command determining unit upon identification of the keyword; and
where the control command determining unit is configured to identify a control command from the control command information.

2. The speech dialogue system of claim 1, where the keyword information and the control command information comprise different sets of information.

3. The speech dialogue system of claim 1, where the keyword comprises at least one word.

4. The speech dialogue system of claim 1, where the keyword comprises one or more numbers.

5. The speech dialogue system of claim 1, where the keyword comprises one or more characters.

6. The speech dialogue system of claim 1, where the speech recognition unit comprises a first vocabulary set comprising at least one vocabulary element corresponding to the keyword; and
the control command determining unit comprises a second vocabulary set comprising at least one vocabulary element corresponding to the control command.

7. The speech dialogue system of claim 6, where the first and second vocabulary sets have at least one common vocabulary element.

8. The speech dialogue system of claim 7 where the common vocabulary element comprises both the keyword and the control command.

9. The speech dialogue system of claim 1, where the control command determining unit is configured to determine a control command from a control command input comprising at least one word.

10. A speech dialogue system of claim 1, further comprising storage means for storing at least part of an acoustic input.

11. The speech dialogue system of claim 10, where the control command determining unit is configured to identify the control command regardless of the position of the keyword relative to the control command.

12. The speech dialogue system of claim 11, where the command control determining unit is configured to identify the control command from the acoustic input in which part or all of the keyword information precedes the control command information.

13. The speech dialogue system of claim 11, where the command control determining unit is configured to identify the control command from the acoustic input in which part or all of the keyword information follows the control command information.

14. The speech dialogue system of claim 1, further comprising acoustic and/or optical output means for outputting an identified control command, where the speech dialogue system is configured to await further acoustic input confirming or rejecting the determined control command.

15. A speech dialogue system of claim 1, further comprising means for noise suppression.

16. A method for controlling an electronic device via speech comprising:
receiving an acoustic input containing keyword information and control command information;
identifying a keyword from the keyword information;
activating a control command determining unit;
identifying a control command from the control command information, and
generating a control command corresponding to the identified control command information.

17. The method of claim 16, where the keyword information and the control command information are different.

18. The method of claim 16, where identifying a keyword comprises comparing the keyword information with a first vocabulary set comprising at least one vocabulary element corresponding to the keyword, and
where identifying a control command comprises comparing the control command information with a second vocabulary set comprising at least one vocabulary element corresponding to the control command.

19. The speech dialogue system of claim 16, where the first and second vocabulary sets have at least one common vocabulary element.

20. The speech dialogue system of claim 17 where the common vocabulary element comprises both the keyword and the control command.

21. The method of claim 15, where the keyword comprises more than one word.

22. The method of claim 15, where the control command comprises more than one word.

23. The method of claim 15, further comprising storing at least part of the acoustic input.

24. The method of claim 23, where the control command determining unit identifies the control command regardless of the position of the keyword relative to the control command.

25. The method of claim 18, further comprising outputting the identified control command via acoustic and/or optical output to the user of the SDS, and
receiving a confirmation or rejection command of the identified control command.

26. The method of claim 15, comprising removing background noise during the step of receiving an acoustic utterance.

27. A computer program product, comprising one or more computer readable media having computer-executable instructions for performing the steps of:
receiving an acoustic input containing keyword information and control command information;
identifying a keyword from the keyword information;
activating a command determining unit;
identifying a control command from the control command information, and
generating a control command corresponding to the identified control command information.

28. The speech dialogue system of claim 1, where the speech dialogue system is associated with a vehicle.

29. The speech dialogue system of claim 1, where the electronic device is selected from the group consisting of telephones, CD players, DVD players, navigation systems, climate control systems, and on-board computers.

30. A speech dialogue system (SDS) for controlling an electronic device comprising:
means for receiving an acoustic input; and
means for identifying a keyword in the acoustic input; and
means for identifying a control command in the acoustic input; and
means for generating a control command for the electronic device.
